(19) United States
(12) Patent Application Publication
(10) Pub. No.: US 2024/0160992 A1
(43) Pub. Date: May 16, 2024

(54) Simplified client and associated architectures for delegating quantum calculations to a quantum server

(71) Applicant: VERIQLOUD, MONTROUGE (FR)

(72) Inventor: Marc KAPLAN, MONTROUGE (FR)

(21) Appl. No.: 18/281,419

(22) PCT Filed: Feb. 17, 2022
(86) PCT No.: PCT/EP2022/053964

§ 371 Date: Sep. 11, 2023

(30) Foreign Application Priority Data
Mar. 10, 2021 (EP) 21305294.7

(51) Int. Cl. G06N 10/80; G06F 7/548

(52) U.S. Cl. CPC G06N 10/80; G06F 7/548

(57) ABSTRACT

A system for delegating a quantum computation from at least one client (10) to a server (20), including: —at least one source (40) adapted to emit a sequence of quantum states, —wherein the server includes a device (21) for measuring received quantum states, and at least one quantum component (22) making it possible to carry out said quantum computation; and said at least one client including an input interface (11) for receiving said sequence, a transformation device (12) adapted to modify a quantum state of said sequence and an output interface (13) for transmitting said sequence to said measurement device.

### FIELD OF THE INVENTION

The present invention relates to quantum computing in general, and in particular to the delegation of a quantum computation from a client to a remote server.

### BACKGROUND OF THE INVENTION

Quantum computing (“quantum computing” in English) is a domain that has been developed over the last decade, because of its numerous promises. It uses the quantum properties of the material, such as the superposition and the entanglement in order to perform operations on data. Unlike a conventional computer working on binary data (coded on bits, equal to 0 or 1), the quantum computer works on “qubits” whose quantum state could have an infinity of values.

Nevertheless, just like high-performance computing (HPC standing for “High Performance Computing”), quantum computing requires the deployment of specific devices for handling these quantum properties of the material. As a result, quantum computers are still expensive systems and an envisaged evolution is based on a client/server paradigm.

According to this model, clients could delegate all or part of the quantum computations to servers, so that most expensive quantum resources could thus be shared for several clients.

It is also envisaged that such servers are accessible via large-scale telecommunications networks, such as the Internet, in the form of a service: “quantum as a Service”, QaaS (or “calcul quantique ala demande” according to a French translation). Thus, the quantum server could be accessible via a cloud computing architecture, or “cloud”.

Hence, clients wishing to delegate a quantum computation from this server should establish a communication channel (which, according to different modalities, may be quantum and/or conventional ones) with this server.

Securing mechanisms have been suggested in order to avoid third parties being able to have knowledge of the performed computations. Also, “blind computing” mechanisms have been suggested in order to avoid the server itself (which may be corrupted) being able to know the performed computations: henceforth, the server performs computations without knowing neither the operations nor the result or even the input values. Thus, it is possible to delegate computations on data to a server without communicating these data, for example in the case where they cannot be legally made public (medical data, training data for machine learning, etc.). It is also possible to protect against possible corruption of the server.

Also, verifiable computing mechanisms have been suggested in order to enable the client to ensure that the server actually performs the requested computations.

These suggestions are described in particular in “Secure Assisted Quantum Computation” by Andrew M. Childs, in Quantum Information and Computation 5, 456 (2005), https://arxiv.org/abs/quant-ph/0111046 or “Universal Blind Quantum Computation” by Anne Broadbent, Joseph Fitzsimmons and Elham Kashefi, in Proceedings of the 50th Annual IEEE Symposium on Foundation of Computer Science (FOCS 2009), pp. 517-526, https://arxiv. org/abs/0807.4154v3

In general, these blind delegated computing mechanisms rely on computing mechanism based on measurement. This mechanism has been described in a series of foundational articles, including “Measurement-based quantum computation” by Briegel, H. J., Brown, D. E., Dür, W., Raussendorf, R. & Van den Nest, M. in Nature Physics 5, 19 (2009), arXiv:0910.1116v2, or “Unconditionally verifiable blind computation” by Joseph F. Fitzsimmons and Elham Kashefi in Phys. Rev. A 96, 012203 (2017), https://arxiv.org/abs/1203.5217 which further discloses how to obtain the verifiability property which makes it possible to identify a server seeking to modify the computation delegated by the client.

The measurement-based computation, MBQC (standing for “Measurement-Based Quantum Computation” in english), is based on a sequence of measurements, in a specific order, of a specific qubit in a predefined entangled quantum states resource.

The communication between the clients and the server may be based on standard schemes such as, for example, a procedure of the “prepare and send” type or a procedure of the “receive and measure” type.

In the protocols of the prepare-and-send type, the client generates quantum states and sends them to the server which is capable of recording them in order to use them in a computation.

In the protocols of the receive-and-measure type, the client receives a quantum state from the server and measures it in an arbitrary measurement base. The server having previously entangled the quantum state sent to the client with a state of its internal memory, the measurement by the client causes a remote preparation of the state in the memory of the server.

Although the paradigm of the delegated quantum computation makes it possible (and is even intended) to provide for clients that are much lighter than the servers, these two procedure types require that the client has, in the first case, a qubits emitter (for example a source of unique photons) to encode the quantum states, and in the second case, a device for measuring the qubits received from the server (for example a single photon detector).

Such devices (sources and detectors) are generally complex and expensive equipments. These costs form a hindrance to the development of the quantum computing, and in particular, to a vast deployment of clients suitable for the delegation of quantum computations to a server, for example deployed on a cloud.

Other mechanisms have been suggested, such as for example Qin Li et al., “Blind quantum computation for a user who only performs single-qubit gates”. Nonetheless, it could be demonstrated that such a mechanism is vulnerable to some attacks and therefore does not offer the verifiability feature.

### SUMMARY OF THE INVENTION

The present invention aims to provide a solution that at least partially overcome the aforementioned drawbacks.

More particularly, according to some embodiments, it aims to simplify the architecture of the clients, in order to lower the cost thereof and thus allow for a greater deployment of quantum clients that can delegate quantum computations to servers, in particular accessible via quantum telecommunication networks at great distance, while keeping the important characteristics of the aforementioned delegations architectures, in particular the blind and secure computation and the verifiability of the delegate computation.

To this end, according to a first aspect, the present invention may be implemented by a method for delegating a quantum computation by at least one client to a server, comprising at least:
a first step comprising the transmission to the server of a description of entanglements to be performed in a quantum memory;
a second step comprising the emission of a sequence of quantum states by a source, distinct from this server, to said at least one client;
a third step comprising a modification of a quantum state of said sequence;
a fourth step comprising the transmission of said sequence to said server;
a fifth step comprising the application of a sequence of measurements according to a given base, within said quantum memory whose content has been entangled according to said description, and the transmission of the result of each measurement to said at least one client.

According to preferred embodiments, the invention comprises one or several of the following features which may be used separately or in partial combination with each other or in total combination with each other:
the quantum states supplied by the source are a superposition of orthogonal states, and the modification performed by the client is in the form Z^{θ+c,π}wherein Z is a Pauli gate according to the Z axis, θ is randomly selected from a list {0; π/4; π/2; 3π/4} and c is randomly selected amongst the 0 and 1 values;
the quantum states supplied by the source are a superposition of orthogonal states, and the method further includes a step of determining a subset of trap qubits and in the third step comprises a modification of qubits neighboring said trap qubits according to said description of entanglements, in the form X^{d}H, wherein H is the Hadamard transformation, X is a Pauli gate according to the X axis and d is selected amongst the 0 and 1 values, and the client implements a step of comparing between a result of a measurement of one of said trap qubits with a result expected for said trap qubit, allowing determining a honesty of said server;
each of the at least one client can modify only part of the quantum states allocated thereto, and transmits said sequence to a subsequent client of a client chain linking it to the server;
this part of the quantum states can be determined by an allocation of a time window;
several clients can successively modify the same quantum state of said sequence.

According to another aspect, the invention may also be implemented by a system for delegating a quantum computation from at least one client (10) to a server (20), including:
at least one source adapted to emit a sequence of quantum states,
and wherein said server includes a device for measuring received quantum states, and at least one quantum component making it possible to carry out said quantum computation; and
said at least one client including an input interface for receiving said sequence, a transformation device adapted to modify a quantum state of said sequence and an output interface for transmitting said sequence to said measuring device.

According to preferred embodiments, the system according to the invention comprises one or more of the following features which may be used separately or in partial combination with each other or in total combination with each other:
this transformation device includes a first device for applying a first transformation intended to prepare quantum states to perform a blind quantum computation, and a second device for applying a second transformation intended to prepare quantum states to verify a honesty of said server;
said first equipment and said second equipment are distributed into distinct physical locations;
a plurality of clients are connected to said server by one single communication line forming a chain, so that said quantum states are progressively transmitted from said source to said measuring device;
each of said clients is configured so to be able to modify only the part of the quantum states allocated thereto;
the quantum states are photons and the transformation device is an optical modulator;
the source is adapted to supply quantum states in the form of a superposition of orthogonal states, and the transformation device is adapted to perform a modification in the form Z^{θ+c,π} wherein Z is a Pauli gate according to the Z axis, θ is randomly selected from a list {0; π/4; π/2; 3π/4} and c is randomly selected amongst the 0 and 1 values.

In general, a system according to the invention is configured to implement the previously defined method, according to its different embodiments.

Further features and advantages of the invention will become apparent from the following description of a preferred embodiment of the invention, given by way of example and with reference to the attached drawings

### BRIEF DESCRIPTION OF THE FIGURES

The attached drawings show the invention:

FIG. 1 schematically represents an example of a system according to an embodiment of the invention.

FIG. 2 illustrates a flowchart of a method according to an embodiment of the invention.

FIGS. 3a, 3b illustrate embodiments with a plurality of clients.

### DETAILED DESCRIPTION OF EMBODIMENTS OF THE INVENTION

In particular, the invention is based on the principle that the client has just a means for transforming quantum information but no means for generating or measuring it, to the extent that the generation and measurement are steps requiring more complex and expensive components.

These steps, or functions, are moved to a server and a source, which makes it possible to pool the resources since a large number of clients may exist and connect to one single server and to one single source. Furthermore, this makes it possible to lower the cost of the clients and therefore to allow for a wider access to quantum technologies through “cloud”-accessible servers (cloud computing).

Also, it becomes possible to lighten and simplify the general architecture by making it possible to connect a plurality of clients to the same server and to the same quantum source by means of one single communication line.

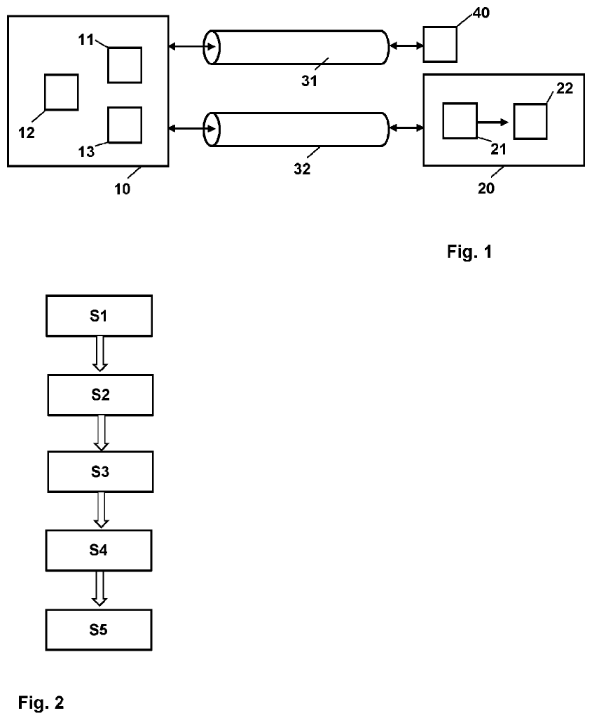

As illustrated in FIG. 1, a client 10 has an input interface 11 adapted to the reception of a sequence of quantum states, a transformation device 12 adapted to the modification of the received quantum states, and an output interface 13 adapted to the emission of the quantum states (possibly modified by the transformation device 12).

The client 10 may have only these three components as quantum components. Of course, it may further have conventional components (in the sense of “non-quantum”), in particular in order to control the transformation device in a manner known per se.

Thus, the client has neither a quantum state source, nor quantum state measurement devices.

Except these two removed elements, the client 10 may be in compliance with the clients described in the literature relating to quantum computation delegation. In particular, the client may be of the type described in the aforementioned articles:
“Secure Assisted Quantum Computation” by Andrew M. Childs, in Quantum Information and Computation 5, 456 (2005), https://arxiv.org/abs/guant-ph/0111046 or
“Universal Blind Quantum Computation” by Anne Broadbent, Joseph Fitzsimmons and Elham Kashefi, in Proceedings of the 50th Annual IEEE Symposium on Foundation of Computer Science (FOCS 2009), pp. 517-526, https://arxiv.org/abs/0807.4154v3

It should be noted that such a client may be a subpart of a computer or a general-purpose equipment, or a standalone equipment that can be connected to such a general-purpose equipment or computer. Different embodiments may be considered in the context of the present invention.

According to the invention, a source 40 is intended to generate and emit a sequence of quantum states to the client, throughout a communication line 31.

Quantum states can be carried by different technologies. According to a preferred implementation, the quantum states are carried by photons.

In general, quantum computing is based on handling data in the form of quantum bits or “qubits”. While in conventional computing, an information bit is used to represent only one of the two possible logic states, namely “1” or “0”, in quantum computing, a qubit may represent the two logic states simultaneously as a superposition of quantum states.

In practice, the qubits may be encoded using the degrees of freedom of different physical particles. The degrees of freedom are a physical property of the physical systems, which can be described by quantum mechanics.

In particular, the qubits may be physically implemented by various supports, in

particular photons, the coherent state of light, electrons, the nucleus of an atom, optical networks, Josephson junctions for superconducting qubits, etc. A non-exhaustive list can be found, for example, on Wikipedia: https://en.wikipedia.org/wiki/Qubit

Consequently, the degrees of freedom depend on the physical support and comprise the phase, the phase differences, the frequency, the polarization, the temporal location of the photons. It is also possible to use the spins of the electrons, the superconducting charge, the number of electrons, etc.

The qubits may be written as a vector in a Hilbert vector space with a dimension d. In a dimension d=2, the qubit may be defined by a base composed of two states, which are denoted |0 [symbol] and |1 [symbol] . Thus, the state |a [symbol] of the qubit may be represented by:

|a [symbol] =a|0 [symbol] +b|1

[symbol]

where a and b are complex number coefficients.

The qubit can store information in the form of a combination of 0 and 1, using different values of a and b. However, a measurement of the qubit will cause it to project on the state |0 [symbol] or |1 [symbol] and return the result 0 or 1 respectively. The probabilities of returning these values are respectively |a|² and |b|².

According to an embodiment of the invention, photons are used as a qubit support. Quantum bits can be encoded with photons according to their degree of freedom. “Photon degree of freedom” refers to a physical property described by quantum mechanics and usable for quantum communications. Examples of photon degrees of freedom are phase, phase difference, frequency, polarization or temporal location.

The source 40 may then be a laser able to generate photons, combined with an initial modulator able to modulate a degree of freedom of a generated photon in order to generate desired quantum states (as will be seen hereinbelow, a superposition of states denoted |+ [symbol] ).

According to one embodiment, the source and the transformation device 12 of the client perform modulations over the time interval for which it is desired to generate/transform a photon, the overall energy of which corresponds to a photon energy quantum.

According to another embodiment, the phase difference is used as a degree of freedom to encode the qubits. Also, the source 40 generates the photons by performing a modulation according to two peaks, each in a half-interval of the interval corresponding to the photon to be generated. The total energy of this modulation being, by configuration, equal to the energy quantum of a photon, each photon thus generated is a superposition of a photon between these two half-intervals.

The laser can be provided with a wavelength of 1550 nm which corresponds to the minimum attenuation in optical fibers commonly used in telecommunications.

The transformation devices 12 may then consist of optical modulators. They are not intended to emit photons but merely to modulate an electromagnetic field in which the photons pass in order to modify a degree of freedom thereof. As will be seen later on, each transformation device may include, according to one embodiment, at least two optical modulators, each intended to modulate the photons according to an axis different from the Bloch sphere representing the selected degree of freedom.

Throughout the communication link 32, the client 10 is in communication with a server 20. The line 32 may be an optical fiber.

A server is also provided, to perform quantum computing by delegation of a client. This server 20 is a piece of equipment distinct from the source. Preferably, it belongs to an entity distinct from this source, in order to avoid any functional collusion. Still preferably, it may be provided that the server has no knowledge of the source.

The server 20 is provided with quantum circuits and possibly conventional circuits (in particular enabling the control of these quantum circuits). In particular, it includes a device 21 for measuring received quantum states.

The server 20 may further include one or more quantum elements 22 making it possible to perform the quantum computations that are delegated to the server. In particular these quantum components may comprise a quantum memory making it possible to store received qubits, means for performing operations on one or more qubits, etc. The nature of these quantum elements depends on the selected technology and on different possible embodiments.

The measuring device 21 of the server 20 may consist of one single photon detector, i.e. capable of measuring the quantum state of an individual photon and not a light flux, or energy. Different mechanisms exist in the prior art. For example, there are detectors based on avalanche photodiodes (APDs, standing for “Avalanche PhotoDiode” in english).

More generally, according to different embodiments of the invention and depending on the type of degree of freedom, different types of modulators and detectors may be used.

When the degree of freedom of photons to encode quantum bits is the phase, the modulators can be phase modulators. For example, the LN53S-FC or LN65S-FC model marketed by Thorlabs can be used.

When the degree of freedom of photons to encode quantum bits is photon polarization, the modulators can be polarization modulators. For example, a model from the PSC-LN series of products marketed by iXblue Photonics can be used.

When the degree of freedom of the photons to encode the quantum bits is the temporal location of the photons, the modulators may each comprise a number d of delay lines and a number 2d of splitter plates, where d represents the dimension of the Hilbert vector space of representation of the quantum states. In order to carry out a blind computation, it can be demonstrated that it is necessary and that it is sufficient to know how to encode states in bases that are incompatible with one another. The superposition of temporal locations to be carried out to encode a qubit in base amongst a set of incompatible bases may be obtained by programming the splitter plates.

In general, photon modulators are standard telecommunication devices, and therefore inexpensive and produced on a large scale.

Other implementations are possible, including implementations that are not based on photons.

In the case where the qubits handled by the server are coupled to the microwave domain (for example superconducting qubit), communication with the client could be achieved:
Either by transduction of the quantum information in the optical domain as described for example in the article “Superconducting qubit to optical photon transduction” by Mohammad Mirhosseini, Alp Sipahigil, Mahmoud Kalaee & Oskar Painter in Nature 588, 599-603 (2020). https://doi.org/10.1038/s41586- 020-3038-6. This makes it possible to apply the previously-described methods to handle photons.
Or by the client using an auxiliary quantum system such as a superconducting qubit, or a semiconductor qubit, for example based on silicon. In particular, the coupling between a superconducting qubit (which can be used by the server) and a semiconductor qubit (which can be used by the client) is described in the article “Coherent microwave-photon-mediated coupling between a semiconductor and a superconducting qubit” by Scarlino, P., van Woerkom, D. J., Mendes, U. C. et al in Nat Commun 10, 3011 (2019). https://doi.org/10.1038/s41467-019-10798-6. After reception and storage of the qubit by the client, the latter could apply a transformation using standard quantum information handling techniques before returning the qubit thus obtained by the server.

In the last case, the client is therefore equipped with a complex quantum system, but limited to one single qubit. It follows that the client is considerably simpler than the server which is capable of handling a larger number of qubits.

Thus, the invention is independent of the type of technologies for encoding and transforming the qubits (quantum states).

Protocol with a Simplified Client

FIG. 2 illustrates a method according to an embodiment of the invention. This embodiment is based on the measurement-based delegated computing mechanisms as described in the aforementioned articles of Childs, and of Broadbent, Fitzsimmons and Kashefi. According to these mechanisms, the server includes a quantum memory that is first prepared in an entangled state. This state, called “cluster state” or “graph state” in English is universal, in the sense that it does not depend on the quantum computation to be performed. It forms a “substrate” on which a subsequent computation phase, as such, may be carried out.

In this computation phase, the client indicates a sequence of measurements to be performed individually on some qubits of the quantum memory of the server, or state graph. These measurements really specify the quantum computation algorithm to be performed on the server. Hence, the quantum algorithm corresponds to an ordered processing of quantum correlations. Hence, it may consist of a sequence of qubit identifiers to be measured associated with a measurement base.

In the context of a blind computation, the state graph and the algorithm (defining the sequence of the measurements to be performed) could be known to all parties. The “secret”, making the computation blind, lies in the individual state of the qubits supplied to the server.

More specifically, in a preparation phase, a step S1 consists in transmitting to the server a description of the computing resource, i.e. of entanglements to be performed in a quantum memory of the server. This step defines the state graph within the server.

To do so, the client sends to the server the (conventional) description of the computing resource. In general, this resource is a quantum state composed of several qubits entangled with one another. The description sent by the client consists of the entanglement relationships between the qubits, but not of the description of the qubits themselves. Indeed, the latter is hidden to the server and, according to the invention, it is subsequently supplied to the server by the client during step S4.

In a step S2, a source 40 emits a state sequence on the input interface 11 of the client.

These quantum states are transmitted via a communication link 31. Typically, this communication link 31 is an optical fiber enabling the transmission of photons, but other implementations are of course possible in the context of the invention.

In a step S3, a transformation means or device 12, applies the necessary transformations for each state, one after another. Thus, the quantum states can be modified, in a blind fashion for the server.

In a conventional blind delegate computation method, masking of the information to the server results from a very specific choice of the states sent by the client to the server. In the process according to the invention, masking of the information is ensured by the combination of a choice of the initial quantum states generated by the source 40, and by the transformations applied by the client.

In particular, the source 40 can generate a sequence of quantum states |+

[symbol]

Each of these states is a superposition of orthogonal states, so that:

$$\vert + 〉 = \frac{1}{\sqrt{2}} ( \vert 0 〉 + \vert \vert 1 〉 )$$

The transformation device 12 can apply transformations, such that the server cannot identify them with certainty.

To do this, these transformations may be in the form:

Z^{θ+c,π}
in which
Z is a Pauli gate according to the Z axis,
θ is randomly selected from a list {0; π/4; π/2; 3π/4}
c is randomly selected amongst the 0 and 1 values

The Pauli-Z gate acts on one single qubit. This is equivalent to a rotation around the Z axis of Bloch sphere by π radians. It leaves the state |0 [symbol] unchanged and transforms the state |1 [symbol] into |1 [symbol] . It can be represented by the Pauli-Z matrix:

$$Z = [ \begin{matrix}1 & 0 \\ 0 & - 1\end{matrix} ]$$

Thus, by applying the transformation Z^{θ+c,π}, the following quantum state is obtained at the output:

|0 [symbol] +e^{θ+c,π}|1

[symbol]

This state is usually denoted |+_{θ+c,π}

[symbol]

Sending such states to the server is sufficient to completely mask the computation performed thereby. The keys making it possible to decrypt the computation and its result are the values θ and c selected for each qubit

In a step S4, the states transmitted to the client are sent to the server after the transformations have been applied.

The rest of the protocol may be in accordance with those described in the literature. Thus, in a step S5, the server applies a measurement sequence on each of the qubits in a predetermined order as mentioned before. The measurement base of each qubit is selected in an interactive manner by communicating the result of each measurement to the client. The client then specifies to the server the base in which the next qubit should be measured, and so on.

The last measurement gives the result of the computation in an encrypted manner. Its result is transmitted to the client which can decrypt it in order to read the result of the computation.

The choice of the transformation Z^{θ+c,π} makes it possible to hide the information to the server. Other transformation choices are also possible.

In particular, other transformations can be used in order to make the protocol verifiable, i.e. to ensure (for the client) that the server actually applies the approved protocol, without altering the operations thereof. In particular, this may be interesting to verify whether the server has not been corrupted and/or whether the server is trustworthy. Indeed, in particular in the context of deployment of a server on a public platform, such as a “cloud”, it could be important, and even essential, to be able to ensure the legitimacy, or honestly, of the server.

A mechanism enabling verification by the client of the computations made by the server has been suggested in the aforementioned article “Unconditionally verifiable blind computation”. This is based on the idea of making the server perform a computation whose result is predictable in order to compare the result obtained from the server with the expected one. To do so, it is necessary to isolate the qubits on which the computation within the state graph are done, i.e. to ensure that they are not entangled with their neighbors, to ensure that the computation is actually predictable.

According to one embodiment, during the preparation phase, the client selects a given number of qubits that will form “traps” for the server. The number of selected qubits is a security parameter: the higher it is, the more difficult it will be for the server to cheat.

The subset of trap qubits may be selected masked to the server, therefore according to a scheme that is unknown thereto. On the other hand, each of these traps has to be isolated, i.e. it should be ensured that they are not, at the time of the measurement, still entangled with other qubits of the quantum memory of the server, so that the result of the measurement is predictable.

Thus, for each qubit linked to a trap qubit in the state graph (which describes the entanglements to be performed between the qubits within the quantum memory of the server), the clients prepares a state with a transformation X^{d}H on the received state |+ [symbol] . These qubits are called “dummy” and are not used by the computation as such.

H represents the Hadamard transformation, X is a Pauli gate according to the X axis and d is selected amongst the 0 and 1 values.

The Hadamard transformation acts on a single qubit and transforms a state |0 [symbol] into a superposition of equiprobable states |+ [symbol] and a state |1 [symbol] in a superposition |− [symbol] . It corresponds to the combination of a π rotation according to the X axis and a π/2 rotation on the Y axis, according to Bloch sphere. It may be represented by Hadamard matrix:

$$H = \frac{1}{\sqrt{2}} \cdot [ \begin{matrix}1 & 1 \\ 1 & - 1\end{matrix} ]$$

The Pauli-X gate acts on one single qubit. This is equivalent to a rotation about the X axis of Bloch sphere by π radians. It is equivalent to a “NO” gate in conventional logics, since it permutes the |0 [symbol] and |1 [symbol] states. It may be represented by Pauli-X matrix:

$$X = [ \begin{matrix}0 & 1 \\ 1 & 0\end{matrix} ]$$

The number d indicates whether the transformation according to Pauli X gate takes place (d=1) or does not take place (d=0).

The trap qubits are prepared by applying a transformation Z^{θ+c,π} on the received state |+ [symbol] .

Still in the preparation phase, when the server applies the state graph to establish the entanglements between adjacent qubits, the entanglement operation performed by the server between a trap qubit and a dummy qubit will have no effect, because of the preparation based on the transformation X^{d}H applied to the state |+ [symbol] .

Thus, the client can instruct the server to perform, on each trap qubit, a measurement from which it can predict the result. If the measurement results match with the predictions, then it knows that the server has not deviated from the computation ordered by the client. Conversely, in the event of too many errors in the measurement results of the trap qubits, the client will know that the server has not carried out the operations in accordance with its instructions. Thus, the client could ensure the honesty of the server.

Thus, this verifiability property, consisting in verifying the honesty or integrity of the server, is achieved by the method and the system according to the invention, in particular by the physical and functional separation between the source and the server.

Thus, a problem can be solved by the mechanisms of the state of the art, for example, as mentioned before, an architecture in which the server itself supplies the quantum state sequences, such as for example the architecture described in Qin Li et al., “Blind quantum computation for a user who only performs single-qubit gates”.

Indeed, it is possible to demonstrate the vulnerability of such an architecture.

A possible fault is the attack described in the article “Delegating Multi-Party Quantum Computations vs. Dishonest Majority in Two Quantum Rounds» (https://arxiv.org/abs/2102.12949) Appendice I, page 48.

This attack consists of the server applying a specific operation, the transformation Z, on each of the qubits before and after transmission to the client. This operation has the effect of modifying the qubits used in the quantum computations. In the context of the described protocol, the effect of these modifications cannot be detected by the client.

On the contrary, the mechanism of the invention allows ensuring that the above-described attack is impossible without a collusion between the source of the qubits and the server. This allows easily implementing a verifiable protocol.

One could notice that the logic gates implemented in step S3, which corresponds to the only quantum handling performed by the clients, correspond to rotations according to different axes in the case of a quantum computation and in the case of verification of the honesty of the server.

According to an embodiment of the invention, the transformation device 21 includes two (or more) distinct devices, each adapted for a particular transformation. Thus, a first device can apply a first transformation aiming to prepare the necessary qubits to perform a quantum computation, and a second device can apply a second transformation aiming to prepare the necessary qubits to verify a honesty of said server. For example, a first device (for example an optical modulator) is adapted to the transformation Z^{θ+c.π}Z^{θ+c.π}, and a second device (for example a second optical modulator) is adapted to the transformation X^{d}H.

### N Clients/1 Server Architectures

As has been seen before, one of the advantages of a client according to the invention consists of its simplicity making it possible to lower the cost and to facilitate deployment on a large scale. In particular, the architecture makes it possible to ensure scaling of the deployment of a quantum “cloud” infrastructure

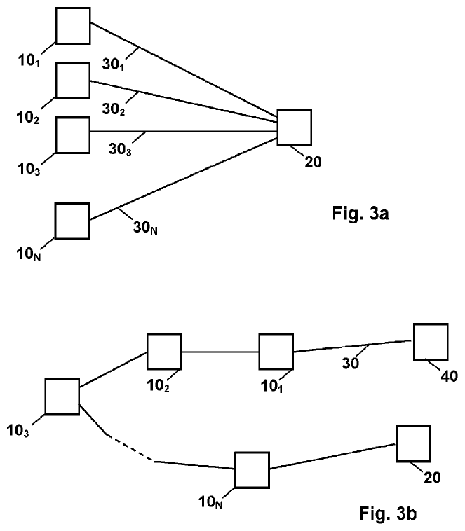

According to an embodiment illustrated in FIG. 3a, it is thus possible to connect a large number of clients 10₁, 10₂, 10₃ . . . 10_{N} to one single server 20, via as many communication lines, respectively 30₁, 30₂, 30₃ . . . 30_{N}. In FIG. 3a, the quantum state source is not represented.

The server 20 may then have a switch enabling it to receive the quantum state sequences emitted by the different clients to its shared quantum resources (in particular the measuring device).

In the case where the client is unique, we then return to the situation illustrated in FIG. 1 and the server obviously does not require the use of a switch.

The simplified client according to the invention also makes it possible to connect several clients to the same server via one single communication line, as illustrated in FIG. 3b.

Thus, in FIG. 3b, one single line 30 connects the source 40, the clients 30₁, 30₂, 30₃ . . . 30_{N}, and the server 20.

Thus, the clients form a chain according to which each client 10ᵢ could have a preceding client 10ᵢ₋₁ in the chain (except the first client 10₁ connected directly to source 40) and a next client 10ᵢ₋₁ (except the last client 10_{N} connected directly to the server 20), so that the quantum states are progressively transmitted from the source 40 to the measuring device 21.

Thus, the server has only one single incoming communication line but its computing capacities are nevertheless shared between all clients, which could be very numerous.

Such an architecture is made possible thanks to the fact that simplified clients according to the invention just have a quantum transformation device. The latter can transform, or not the quantum states that are transmitted thereto, so that the quantum states are modified only by the desired client(s).

According to the invention, the quantum state constructor (source) and destructor (measurement) devices are relegated to the end of the chain and therefore do not disturb the end-to-end transmission via a plurality of intermediate clients.

According to one embodiment, the communication line may be shared, or pooled, between the different clients connected thereto, by allocating thereto part of the quantum states supplied by the source 40.

Thus, each client of the chain can just modify the part of the quantum states allocated thereto, and transmits the entire sequence to the next client in the chain (or to the server for the last one).

For example, this part may be determined by an allocation of a time window. Thus, a window separate from the other clients of the chain is allocated to each client and (possibly) modifies only the quantum states received in the window allocated thereto. Hence, each quantum state emitted by the source can be modified only by one single client of the chain.

These time windows may be periodic, i.e. the time axis may be subdivided into periods, and each period subdivided into an ordered sequence of time windows individually allocated to a client and whose order is preferably identical from one period to another.

Thus, a simple time demultiplexing could enable the server 20 to know, at each time point, with which client it is interacting.

21 As mentioned before, the server 20 and the source 40 are distinct in order to ensure the verifiability property.

They can be implemented by distinct and standalone physical equipment. In particular, each may have independent microprocessors, and an independent power supply source. They may also be located in distinct geographical locations.

Preferably, the source and the server are functionally independent and are adapted so as not be able to interact except by the transmission of the quantum states from the source to the server via the clients. Thus, it is possible to guarantee the absence of collusion, or agreements, between these two entities.

Nonetheless, they may belong to the same legal entity, in the case where the latter could be considered to be trustworthy. For example, this may be the case of a legal entity having a specific certificate guaranteeing honest behavior, for example a telecommunications operator; the latter could provide an equipment to generate the quantum states in a first location, and another equipment to measure them (and perform the quantum processing) in a second distinct location, without these functionally communicating (excluding any need for management and administration).

According to one embodiment, several clients may interact with the same qubit generated by the source. Thus, several clients could, successively, modify the same quantum state of the sequence of states generated by the source.

Thus, a first client can modify part of the transmitted quantum states, and at least one second client can again modify all or part of these quantum states. These first and second clients can represent only part of the client chain and are not necessarily successive.

According to one embodiment, a subpart of the sequence of quantum states, corresponding for example to a time window, may be allocated to such a plurality of clients.

This possibility of successive modifications of the same quantum state by several clients makes it possible to perform multi-party computations, i.e. to prepare a state intended to the server whose inputs depend on several clients.

Thus, the invention allows for new types of computations that were not possible with conventional computing mechanisms delegated from one single client to a server.

In particular, this task may be useful to carry out a secure multi-party computation, i.e. a computation that depends on the inputs of several clients, but performed so as not to reveal said inputs. This type of computation is described for example in “Multiparty Delegated Quantum Computing” by Elham Kashefi and Anna Pappa, in Cryptography 2017, 1(2), 12, https://arxiv.org/abs/1606.09200v2 or “Actively Secure Two Party Evaluation of any Quantum Operation” by Frédéric Dupuis, Jesper Buus Nielsen and Louis Savail, in Proceedings of the 32nd Annual Cryptology Conference on Advances in Cryptology, vol. 7417, August 2012, https://doi.org/10.1007/978-3-642-32009-5 46

According to an implementation based on that of the aforementioned article by Elham Kashefi and Anna Pappa, it is possible to modify the described protocols in order to apply them to the context of a simplified client.

Thus, in the protocol 1 described in page 8, each client involved in the multi-party computation sends a state in the form |+_{θi} [symbol] . Afterwards, the server who received all these states carries out an operation that enables it to prepare the state |+_{θ} [symbol] , where θ is the sum of all θᵢ (protocol 3). This state forms the resource that enables the server to carry out a multi-party delegate computation (protocol 4).

Thanks to the combined advantages of a simplified client and an online architecture of a customer chain, it is possible to directly prepare this state |+_{θ}

[symbol]

For this purpose, starting from the state |+ [symbol] generated by the source, each client involved in the computation has just to perform the rotation Z^{θi} corresponding to its input θᵢ. The aggregate, rotations performed successively by each of the involved clients makes it possible to prepare the state |+_{θ} [symbol] at the output of the last client (and therefore at the input of the server).

Hence, this architecture considerably simplifies the phase of preparation of the initial state of the computation.

Of course, the present invention is not limited to the examples and embodiment described and shown, but is defined by the claims. In particular, it is susceptible to numerous variants accessible to the skilled artisan.

1. A method for delegating a quantum computation by at least one client to a server, comprising
a first step comprising the transmission to the server of a description of entanglements to be performed in a quantum memory;
a second step comprising the emission of a sequence of quantum states by a source, distinct from said server, to said at least one client;
a third step comprising a modification of a quantum state of said sequence, a fourth step comprising the transmission of said sequence to said server;
a fifth step comprising the application of a sequence of measurements according to a given base, within said quantum memory whose content has been entangled according to said description, and the transmission of the result of each measurement to said at least one client.

2. The method of claim 1, wherein the quantum states supplied by said source are a superposition of orthogonal states, and the modification performed by said client is in the form Z^{θ+c.π}wherein Z is Pauli gate according to the axis Z, θ is randomly selected from a list {0; π/4; π/2; 3π/4} and c is randomly selected amongst the 0 and 1 values.

3. The method according to claim 1, wherein the quantum states supplied by said source are a superposition of orthogonal states, and including a step of determining a subset of trapped qubits and wherein said third step comprises a modification of qubits neighboring said trap qubits according to said description of entanglements, in the form X^{d}H, wherein H is the Hadamard transformation, X is a Pauli gate according to the X axis and d is selected amongst the 0 and 1 values, and said client implements a step of comparing a result of a measurement of one of said trap qubits with an expected result for said trap qubit, allowing determining a honesty of said server.

4. The method of claim 1, wherein each of said at least one client can modify only part of the quantum states allocated thereto, and transmits said sequence to a subsequent client of a client chain linking it to said server.

5. The method of claim 4, wherein said part is determined by an allocation of a time window.

6. The method of claim, wherein several clients successively modify the same quantum state of said sequence.

7. A system for delegating a quantum computation from at least one client to a server, including
at least one source adapted to emit a sequence of quantum states,
wherein the server includes a measurement device for measuring received quantum states, and at least one quantum component making it possible to carry out said quantum computation; and
said at least one client including an input interface for receiving said sequence, a transformation device adapted to modify a quantum state of said sequence and an output interface for transmitting said sequence to said measuring device.

8. The system of claim 7,
wherein said transformation device includes a first device for applying a first transformation aiming to prepare quantum states for performing a blind quantum computation, and a second device for applying a second transformation aiming to prepare quantum states to verify a honesty of said server.

9. The system of claim 7, wherein the source and the measurement device are distributed into distinct physical locations.

10. The system of claim 7, wherein a plurality of clients are connected to said server by one single communication line-by forming a chain, so that said quantum states are progressively transmitted from said source to said measurement device.

11. The system of claim 10, wherein each of said clients is configured so as to be able to modify only the part of the quantum states allocated thereto.

12. The system of claim 7, wherein said quantum states are photons and said transformation device is an optical modulator.

13. The system of claim 7, wherein said source is adapted to supply quantum states in the form of a superposition of orthogonal states, and said transformation device is adapted to perform a modification in the form wherein Z is a Pauli gate according to the axis, θ is randomly selected from a list {0; π/4; π/2; π/4} and c is randomly selected amongst the 0 and 1 values.

14. (canceled)
